(19) United States
(12) Patent Application Publication
(10) Pub. No.: US 2006/0242969 A1
(43) Pub. Date: Nov. 2, 2006

(54) System and method for vaporizing cryogenic liquids using a naturally circulating intermediate refrigerant

(75) Inventors: Bill R. Minton, Houston, TX (US); David A. Franklin, Houston, TX (US); Martin J. Rosetta, Houston, TX (US)

Correspondence Address: F. LINDSEY SCOTT;LAW OFFICE OF F. LINDSEY SCOTT, 2329 COIT ROAD, SUITE B, PLANO, TX, 75075-3796, US

(73) Assignee: Black & Veatch Corporation

(21) Appl. No.: 11/115,058

(22) Filed: Apr. 27, 2005

(51) Int. Cl. F25B 43/02; F17C 9/02

(52) U.S. Cl. 62/50.2

(57) ABSTRACT

A system and a method for vaporizing a cryogenic liquid using a naturally circulating intermediate refrigerant.

### FIELD OF THE INVENTION

The present invention relates to a system and method for vaporizing cryogenic fluids using a naturally circulating intermediate refrigerant in a thermal siphon type arrangement wherein a first heat exchanger is positioned above a second heat exchanger so that the intermediate refrigerant is vaporized in the second heat exchanger with the vapor passing upwardly into the first exchanger for heat exchange with a cryogenic liquid with a condensed intermediate refrigerant liquid being recovered and passed back to the second heat exchanger by gravity flow.

### BACKGROUND OF THE INVENTION

In many areas of the world, large natural gas deposits are found, which are remote from any commercial market for the volumes of natural gas available. Accordingly, methods have been considered for moving natural gas to commercial markets by pipeline and by liquefaction of the natural gas followed by transport by ship and the like. When the natural gas is liquefied and transported by ship or the like to a destination it is necessary to revaporize the liquefied natural gas (LNG) for use as a natural gas.

Many approaches have been used for such vaporization or revaporization. For instance, seawater is frequently used as a heating medium to vaporize the LNG since seawater is normally present at the unloading area. A continuing problem, however, is the large surface area required in the heat exchangers for revaporization of the LNG by seawater as a heating medium. Further, the use of seawater results in contamination of the heat exchanger surfaces in many instances so that frequent cleaning is required. Further, when lower flow rates of seawater or excessively high rates of cryogenic liquid are used, the seawater can freeze in the seawater side of the heat exchange system used. This can result in damage to the system as well as interrupting production of vaporized cryogenic material. Accordingly, an improved method has been sought to accomplish the desired heat exchange efficiently and in a smaller area, which is of tremendous benefit when the regasification is accomplished offshore and the like.

### SUMMARY OF THE INVENTION

According to the present invention, it has been found that cryogenic liquids are readily revaporized by a method for vaporizing a cryogenic fluid using a naturally circulating intermediate refrigerant, the method comprising: passing the cryogenic liquid in heat exchange contact with a vaporous intermediate refrigerant in a first heat exchanger having a vaporous intermediate refrigerant inlet and a liquid intermediate refrigerant outlet to heat the cryogenic fluid to produce a gaseous cryogenic fluid and a liquid intermediate refrigerant; passing the liquid intermediate refrigerant in heat exchange contact with a heating fluid in a second heat exchanger having a liquid intermediate refrigerant inlet and a vaporous intermediate refrigerant outlet to heat the intermediate refrigerant to produce the vaporous intermediate refrigerant, the first heat exchanger being above the second heat exchanger; allowing the vaporous intermediate refrigerant to rise into the first heat exchanger; and, allowing the liquid intermediate refrigerant to flow downwardly into the second heat exchanger

The invention further comprises a system for vaporizing a cryogenic liquid using a naturally circulating intermediate refrigerant, the system comprising: a first heat exchanger having a liquid cryogenic fluid inlet, a vaporized cryogenic fluid outlet, a vaporized intermediate refrigerant inlet and a liquid intermediate refrigerant outlet; and, a second heat exchanger having a liquid refrigerant inlet, a vaporized refrigerant outlet, a heating fluid inlet and a heating fluid outlet, the first heat exchanger being positioned above the second heat exchanger with the vaporized intermediate refrigerant inlet to the first heat exchanger being in fluid communication with the vaporized intermediate refrigerant outlet from the second heat exchanger and with the liquid intermediate refrigerant outlet from the first heat exchanger being in fluid communication with the liquid intermediate refrigerant inlet to the second heat exchanger.

### BRIEF DESCRIPTION OF THE DRAWINGS

FIG. 1. is a schematic embodiment of the present invention and comprises a heat exchanger comprising two tube bundles in a vertical position inside a low pressure vessel with a welded plate type heat exchanger as an intermediate refrigerant reboiler;

FIG. 2. is a schematic diagram of a further embodiment of the present invention using a plate type heat exchanger for both the vaporization of the cryogenic liquid and for vaporizing of the intermediate refrigerant;

FIG. 3 is a schematic diagram of a further embodiment of the present invention wherein a superheater is provided to superheat the refrigerant vapor;

In FIG. 4. a superheater is used to superheat the vaporized natural gas; and,

In FIG. 5 an intermediate separation vessel is used between the intermediate refrigerant vapor outlet from the intermediate refrigerant heater and the liquid intermediate refrigerant outlet from the cryogenic liquid vaporizing section.

### DESCRIPTION OF PREFERRED EMBODIMENTS

In the description of the FIGs, the same numbers will be used throughout to refer to the same or similar components.

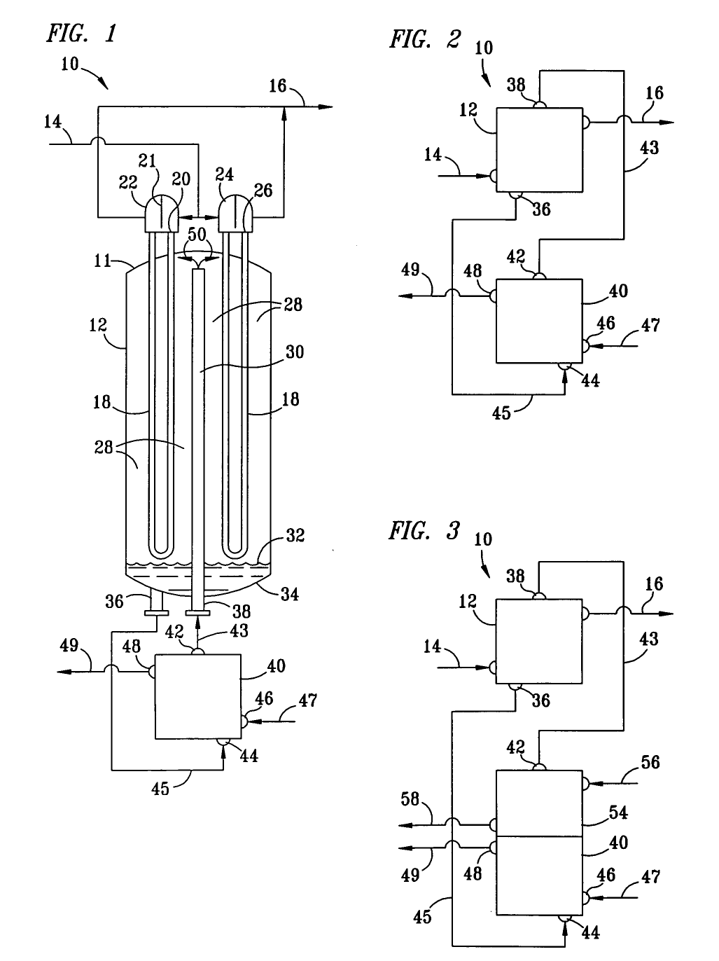

In FIG. 1 an embodiment of the process is shown which uses a typical shell and tube heat exchanger in a vertical configuration. Vaporization system 10 comprises a refrigerant condenser and cryogenic liquid vaporizer having a top 11. The refrigerant condenser (first heat exchanger) 12 includes a cryogenic liquid inlet 14 and a vaporized cryogenic fluid outlet 16. As shown, line 14 passes liquid cryogenic material into a zone established by a divider 21 and a header 20 and into an inlet of tube bundles 18. The vaporized cryogenic material is recovered through an outlet from tubes 18 through a header 22 and passed to line 16. Two headers for the two tube bundles 18 are shown. The second bundle of tubes is shown as receiving the cryogenic liquid through a header 24 into the tube bundles 18 and recovering the vaporized cryogenic material through a header 26 from an outlet from tube bundles 18 in header 26. A variety of arrangements can be used to pass the cryogenic material through headers into heat exchange tubes as well known to those skilled in the art. The embodiment shown is illustrative only.

The first heat exchanger 12 also includes a refrigerant vapor inlet 38 through which refrigerant vapor is introduced and passes upward through a riser 30 and outwardly into a space for refrigerant vapor 28, as shown by arrows 50. The vapor then exchanges heat with the cryogenic fluid in tube bundles 18 and condenses into a liquid intermediate refrigerant material. A representative liquid level 32 is shown in a bottom 34 of heat exchanger 12. The liquid intermediate refrigerant is passed through an outlet 36 through a line 45 and into an inlet 44 into a second heat exchanger 40. In second heat exchanger 40, the intermediate refrigerant is heated by heat exchange contact with a heat exchange fluid passed into heat exchanger 40 via an inlet 46 and a line 47. The intermediate refrigerant is vaporized in second heat exchanger 40 by heat exchange with the heat exchange fluid which is then discharged through an outlet 48 and a line 49. Refrigerant vapor is discharged through a line 42 and passes upwardly through a line 43 into a vaporous refrigerant inlet 38 into first heat exchanger 12. In the operation of the heat exchanger system, the liquid head in bottom 34 of first heat exchanger 12 supplies the motive force to flow liquid intermediate refrigerant back through line 45 into inlet 44 into second heat exchanger 40. The vaporized heat exchange fluid is then passed upwardly into first heat exchanger 12 as a vapor. This cycle is a repeating cycle and provides a supply of heat to first heat exchanger 12 from second heat exchanger 40 without the need for mechanical pumps or the like.

It will be understood that a wide variety of types of heat exchangers could be used. For instance, either or both of the first and second heat exchangers could be a shell and tube heat exchanger of a variety of configurations, a core-in-kettle heat exchanger, a plate fin heat exchanger, a plate type heat exchanger, multiple tube bundles in a shell heat exchanger and the like as known to those skilled in the art. Any such heat exchanger is considered to be suitable although it is preferred that plate type heat exchangers be used.

Plate type heat exchangers are marketed by many suitable suppliers. Printed circuit heat exchanges are a type of plate heat exchanges and are marketed by HEATRIC. Printed circuit heat exchangers are extremely compact, high efficiency heat exchangers which readily tolerate high pressure and have extreme temperature capabilities. The printed circuit heat exchangers basically are prepared by etching a flow path into a plate with a matching flow path being etched into another plate with the two plates then being joined, as known to those skilled in the art. The plates are stacked and may be diffusion bonded and also welded if desired. These plates can have a wide variety of heat exchange paths and are considered to be well known to those skilled in the art. Because of their high efficiency and compact configuration, plate heat exchangers are preferred for use in the process of the present invention. They are also configured to provide certain advantages with respect to their cleaning and use generally when seawater is used as a heat exchange material.

It should be noted that not only seawater but any other suitable liquid or vapor which is warm relative to the cryogenic liquid and at a temperature sufficient to vaporize the intermediate refrigerant can be used as a heat exchange fluid in the second heat exchanger. Some such materials are freshwater, seawater, light hydrocarbons, steam, air, quench water and refinery waste heat streams and the like.

Desirably the intermediate refrigerant is a material such as propane, mixed refrigerants, fluorocarbon refrigerants, chlorofluorocarbon refrigerants, such as the family of FREON refrigerants produced by DuPont and the like, which do not freeze at cryogenic temperatures, i.e., below −100° F. A primary criterion in the intermediate refrigerant is that it be readily vaporized by the heat exchange fluid available and that it be effective to convey heat to the first heat exchanger and condense in heat exchange contact with the cryogenic liquid. Since most intermediate refrigerants will readily condense at the temperature of the cryogenic liquid, a primary consideration is the ready vaporization of the intermediate refrigerant by the heat source available. It is further desirable that the intermediate refrigerant remain liquid in contact with the heat exchange surfaces in contact with the liquid cryogenic fluid in the first heat exchanger. The refrigerants named are considered to meet these criteria. Certain of the refrigerants may be more desirable than others for certain applications.

In alternate embodiments of the present invention, shown for instance in FIG. 2, a plate type heat exchanger may be used for both the first heat exchanger 12 and the second heat exchanger 40. The flow through these plate type heat exchangers is as discussed previously. For instance, the intermediate refrigerant vapor is produced from an intermediate refrigerant vapor outlet 42 from the second heat exchanger and passed through a line 43 to an inlet 38 to first exchanger 12 where a cryogenic fluid is introduced through a line 14 and recovered through line 16 in a revaporized or partially revaporized form. The condensed intermediate refrigerant is recovered through an outlet 36 from first heat exchanger 12 and passed via a line 45 to second heat exchanger 40.

As shown in FIG. 2, a heating fluid is introduced through an inlet 46 and a line 47 and discharged via an outlet 48 through a line 49. The operation of the first and second heat exchanger in combination is as discussed previously with the condensed liquid intermediate refrigerant discharged through outlet 36 supplying the necessary fluid head for movement of the intermediate refrigerant through line 45 to inlet 44 to second heat exchanger 40. The vapor is discharged through line 42 and line 43 to inlet 38 with the operation of the refrigerant flow being completely by gravity by a thermal siphon type process. This type process presents significant advantages in that no pumps are necessary for the circulation of the intermediate refrigerant, although a pump could be used if desired. Since the refrigerant is a material not readily frozen in contact with the heat exchange surfaces containing the cryogenic liquid and is readily vaporized in the second heat exchanger, an efficient heat transfer is accomplished without exposing the heating fluid in line 47 to direct contact with heat exchange surfaces containing the cryogenic liquid. This is a significant advantage with respect to the freezing of the heat exchange fluid during periods of slow heat exchange fluid flow or high flows of cryogenic fluid.

Desirably outlet 36 is placed sufficiently above inlet 44 to provide the necessary heat for the desired flow. The height is typically at least about two feet and is preferably from about two to about ten feet. More preferably, the height is at least about six feet and desirably from about six to about ten feet.

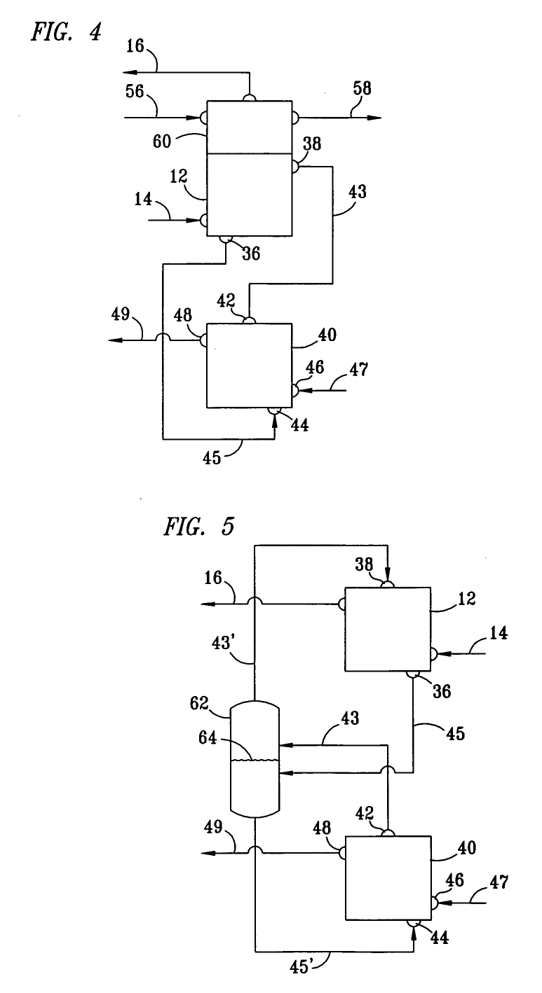

In FIG. 3, another embodiment is shown. In this embodiment, a superheater 54 is used with a second heating medium supplied through a line 56 and recovered through a line 58 to superheat the intermediate refrigerant vapor, which is then passed through an outlet 42 from superheater 54 through a line 43 into an inlet 38 to first heater 12. The liquid refrigerant is returned as discussed previously through line 44 to second heater 40.

In FIG. 4, a further embodiment is shown wherein a superheater 60, heated by heating material supplied through line 56 and recovered through line 58, is used to superheat the recovered cryogenic material which has been liquefied in heat exchanger 12 (downstream). In other aspects the flow of material is as described previously.

In FIG. 5, a further embodiment is shown where a separator 62, having a liquid level 64, is used to ensure the separation of liquid and vapor from the streams in lines 43 and 45. The liquid refrigerant passed from outlet 36 through line 45 to separator 62 is desirably all liquid. Accordingly, this stream is introduced into separator 62 below the liquid level 64 in separator 62. Similarly, the stream recovered via outlet 42 and passed through line 43 to separator 62 is desirably all vapor. This stream is introduced into separator 62 at a level above liquid level 64 and a vapor stream is then passed onward through line 43′ to inlet 38 to vessel 12. Similarly, a liquid stream is recovered from separator 62 and passed through line 45′ to inlet 44 to heat exchanger 40. This embodiment ensures that the vaporous intermediate refrigerant is passed as a vapor to first exchanger 12 and that the liquid intermediate refrigerant is passed to second heat exchanger 40 as a liquid.

It should be understood that liquid may be entrained with the vapor passed to first heat exchanger 12 and that vapor may be absorbed or contained in the intermediate refrigeration stream passed back to second heat exchanger 40. Such inclusion of liquid or vapor does not affect the operation of either vessel significantly since the vessels each act substantially as a separation vessel in their own right, as well as heat exchangers.

Accordingly to the present invention, an intermediate refrigerant is used which is not prone to freeze on heat exchange surfaces in contact with the cryogenic liquids. Clearly when a material such as seawater is used as a heat exchange material, there is always a risk that seawater in contact with heat exchange surfaces contacting cryogenic materials may freeze, thus obstructing the passage of additional heat exchange material and resulting in even greater freezing of the vessel. Since the freezing may be relatively sudden considering the radical difference in temperature between the seawater and the cryogenic materials, this can result in substantial damage to heat exchange surfaces in a very short period of time. These problems are avoided by the present invention wherein an intermediate refrigerant resistant to freezing in contact with surfaces contacting cryogenic liquids is used.

Further the plate type heat exchangers used in the present invention are very readily cleaned in the event that pollution of the heat exchange surfaces occurs as a result of the passage of the seawater. The occurrence of pollution is minimized because the differential temperature across the heat exchange surfaces is much less. Further the environmental problems resulting from discharging seawater at a very low temperature into the sea are avoided. By the present invention, the heat exchange can be a lower temperature since the heat of vaporization is supplied by seawater which can be used readily in larger volumes since the plate type heat exchangers are very efficient and occupy a relatively small area. Since the heat of vaporization is transferred to the cryogenic fluid, a greater heat transfer can be achieved than if only sensible heat were available for transfer to the cryogenic liquid. Further, the present invention reduces the need for pumping an intermediate refrigerant, thereby making the process more energy efficient.

By positioning the heat exchangers so that the second heat exchanger is below the first heat exchanger and so that the superheaters are above the first heater and the second heater respectively, much less area is required for the installation of a revaporizing system having sufficient capacity to handle large quantities of cryogenic liquid. Further, systems of these types could readily be placed side by side so that the appropriate number of systems could be used to vaporize a desired cryogenic fluid at a desired rate. It is clear that the inlet and outlet from the second heat exchanger could be positioned to draw seawater from a substantial distance from the platform and discharge it a substantial distance from a platform or other facility.

In summary, the present invention has provided a highly efficient and high effective method and system for revaporizing a cryogenic liquid by the use of an intermediate refrigerant, which is not prone to the problems associated with the use of most commonly used heat exchange materials used to revaporize cryogenic liquids.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A method for vaporizing a cryogenic fluid using a naturally circulating intermediate refrigerant, the method comprising:
a) passing the cryogenic liquid in heat exchange contact with a vaporous intermediate refrigerant in a first heat exchanger having a vaporous intermediate refrigerant inlet and a liquid intermediate refrigerant outlet to heat the cryogenic fluid to produce a gaseous cryogenic fluid and a liquid intermediate refrigerant;
b) passing the liquid intermediate refrigerant in heat exchange contact with a heating fluid in a second heat exchanger having a liquid intermediate refrigerant inlet and a vaporous intermediate outlet to heat the intermediate refrigerant to produce the vaporous intermediate refrigerant, the first heat exchanger being above the second heat exchanger;
c) allowing the vaporous intermediate refrigerant to rise into the first heat exchanger; and,
c) allowing the liquid intermediate refrigerant to flow downwardly into the second heat exchanger.

2. The method of claim 1 wherein the cryogenic fluid is liquefied natural gas.

3. The method of claim 1 wherein the first heat exchanger comprises at least one of a shell and tube heat exchanger, a core-in-kettle heat exchanger, a plate fin heat exchanger, a plate type heat exchanger, and multiple tube bundles in a shell heat exchanger.

4. The method of claim 1 wherein the first heat exchanger is a plate type heat exchanger.

5. The method of claim 1 wherein the first heat exchanger is a printed circuit heat exchanger.

6. The method of claim 1 wherein the heating fluid is seawater.

7. The method of claim 1 wherein the refrigerant comprises at least one propane, a mixed refrigerant, a fluorocarbon refrigerant and a chlorofluorocarbon refrigerant.

8. The method of claim 1 wherein the first heat exchanger is a printed circuit heat exchanger and the second heat exchanger is a plate type heat exchanger.

9. The method of claim 1 wherein the cryogenic fluid is further heated in a third heat exchanger downstream from the first heat exchanger.

10. The method of claim 1 wherein the intermediate refrigerant is further heated in a fourth heat exchanger between the second heat exchanger and the first heat exchanger.

11. The method of claim 1 wherein the liquid intermediate refrigerant outlet from the first heat exchanger is placed sufficiently above the liquid intermediate inlet to the second heat exchanger to assure natural circulation of the refrigerant.

12. The method of claim 1 wherein the liquid intermediate refrigerant outlet from the first heat exchanger is at least about two feet above the liquid intermediate inlet to the second heat exchanger.

13. A system for vaporizing a cryogenic liquid using a naturally circulating intermediate refrigerant, the system comprising:
a) a first heat exchanger having a liquid cryogenic fluid inlet, a vaporized cryogenic fluid outlet, a vaporized intermediate refrigerant inlet and a liquid refrigerant outlet;
b) a second heat exchanger having a liquid refrigerant inlet, a vaporized refrigerant outlet, a heating fluid inlet and a heating fluid outlet, the first heat exchanger being positioned above the second heat exchanger with the vaporized intermediate refrigerant inlet to the first heat exchanger being in fluid communication with the vaporized intermediate refrigerant outlet from the second heat exchanger and with the liquid intermediate refrigerant outlet from the first heat exchanger being in fluid communication with the liquid intermediate refrigerant inlet to the second heat exchanger.

14. The method of claim 13 wherein the liquid intermediate refrigerant outlet from the first heat exchanger is placed sufficiently above the liquid intermediate inlet to the second heat exchanger to assure natural circulation of the refrigerant.

15. The system of claim 13 wherein the liquid refrigerant outlet of the first heat exchanger is at least about two feet above the liquid refrigerant inlet into the second heat exchanger.

16. The system of claim 13 wherein a third heat exchanger is positioned in fluid communication with the vaporized cryogenic fluid outlet to heat the vaporized cryogenic fluid.

17. The system of claim 13 wherein a fourth heat exchanger is positioned in fluid communication with the vaporized intermediate refrigerant outlet to heat the vaporized intermediate refrigerant.

18. The system of claim 13 wherein a vessel is positioned in fluid communication with the liquid intermediate refrigerant outlet, the vaporized intermediate refrigerant outlet, the liquid intermediate refrigerant inlet, and the vaporized intermediate refrigerant inlet to separate vaporized and liquid intermediate refrigerant for passage to the vaporized intermediate refrigerant inlet and to the liquid intermediate refrigerant inlet respectively.

19. The system of claim 13 wherein each of the first heat exchanger and the second heat exchangers comprises at least one of a shell and tube heat exchanger, a core-in-kettle heat exchanger, a plate fin heat exchanger, a plate type heat exchanger and multiple tube bundles in a shell heat exchanger.

20. The system of claim 13 wherein each of the first heat exchanger and the second heat exchanger comprise a plate type heat exchanger.
